(19) United States
(12) Patent Application Publication
(10) Pub. No.: US 2025/0392417 A1
(43) Pub. Date: Dec. 25, 2025

(54) SEQUENCE-BASED GROUP COMMON DOWNLINK CONTROL INFORMATION (GC-DCI)

(71) Applicant: QUALCOMM Incorporated, San Diego, CA (US)

(72) Inventors: Wei YANG, San Diego, CA (US); Pinar SEN, San Diego, CA (US); Vamsi Krishna AMALLADINNE, Fullerton, CA (US); Jing JIANG, San Diego, CA (US)

(21) Appl. No.: 18/747,842

(22) Filed: Jun. 19, 2024

(51) Int. Cl. H04L 5/00; H04L 1/1812

(52) U.S. Cl. CPC H04L 5/0005; H04L 1/1812; H04L 5/0048

(57) ABSTRACT

Certain aspects of the present disclosure provide techniques for conveying control information to multiple users. A method for wireless communications by an apparatus generally includes receiving a superimposed signal over a set of time frequency resources, the superimposed signal corresponding to a group common downlink control information (GC-DCI), the superimposed signal comprising a combination of a plurality of sequences; detecting, among the plurality of sequences, at least one sequence of a first set of sequences associated with the apparatus; and decoding the at least one sequence to obtain data for the apparatus.

### FIELD OF THE DISCLOSURE

Aspects of the present disclosure relate to wireless communications, and more particularly, to signaling designs for conveying control information to multiple users.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving a superimposed signal over a set of time frequency resources, the superimposed signal corresponding to a group common downlink control information (GC-DCI), the superimposed signal comprising a combination of a plurality of sequences; detecting, among the plurality of sequences, at least one sequence of a first set of sequences associated with the apparatus; and decoding the at least one sequence to obtain data for the apparatus.

Another aspect provides a method for wireless communications by an apparatus. The method includes generating a superimposed signal comprising a combination of a plurality of sequences associated with a plurality of user equipment (UE) groups, wherein each sequence of the plurality of sequences is based on a respective bit pattern corresponding to data for a respective UE group associated with the sequence; and sending the superimposed signal over a set of time frequency resources, the superimposed signal corresponding to a GC-DCI.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example process for group common downlink control information (GC-DCI) construction and transmission to a group of UEs.

FIG. 6 depicts a process flow for communications in a network between a network entity and a UE for constructing and transmitting a superimposed signal including a combination of multiple sequences associated with multiple UE groups over a set of time frequency resources.

FIG. 7 depicts example sequence selection for multiple UE groups.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for conveying control information to multiple users (e.g., user equipments (UEs)). More specifically, aspects herein provide sequence-based signaling designs that may be used to convey, to multiple UEs, separate control information messages as separate sequences combined in a superimposed signal. For example, the superimposed signal may correspond to a group common downlink control information (GC-DCI) where separate control information messages are multiplexed on a same set of time-frequency resources. While aspects herein are described with respect to the transmission of control information to multiple UEs using sequence-based signaling, aspects of the present disclosure may likewise be applicable to the transmission of other types of data where the data is transmitted to multiple nodes as separate sequences combined in a superimposed signal.

In wireless communications networks, data and signaling messages may be carried in downlink and uplink physical channels. For example, a physical downlink shared channel (PDSCH) may be used for carrying user data from a network entity (e.g., such as a base station (BS)) to a UE. Similarly, a physical uplink shared channel (PUSCH) may be used for carrying user data from a UE to a network entity. A physical downlink control channel (PDCCH) may play an important role in, for example, scheduling resources (e.g., time-frequency resources) for PDSCH reception, as well for scheduling grants (e.g., configuring uplink resources) enabling transmission on the PUSCH. For example, the PDCCH may be used to convey control information, referred to as “downlink control information (DCI).” The DCI may include scheduling information for the uplink and/or downlink data channels and/or other control information.

In certain aspects, the control information conveyed via a DCI may be intended for a single UE. For example, the DCI may be a UE-specific DCI including cyclic redundancy check (CRC) bits scrambled by a radio network temporary identifier (RNTI) unique to the UE. Accordingly, only the UE may be able to decode the UE-specific DCI and receive the control information.

In certain other aspects, control information conveyed via a DCI may be intended for a group of UEs. For example, the group of UEs may be configured with a RNTI common to the group of UEs (e.g., a “common RNTI”). The DCI may be a GC-DCI including CRC scrambled by the common RNTI such that only UEs in the group are able to decode the GC-DCI and receive the control information.

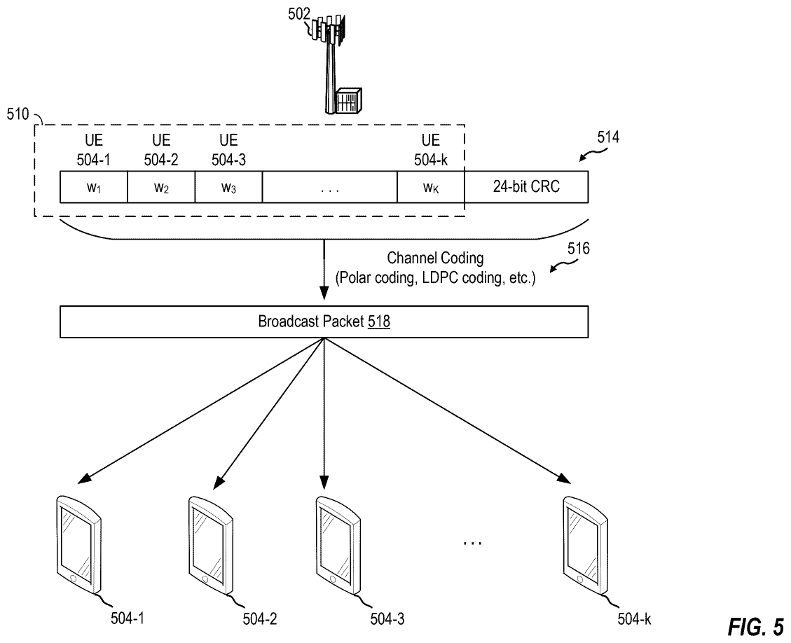

In some cases, a GC-DCI may be constructed by concatenating control information bits (e.g., x-bit control messages) intended for a group of UEs to create a larger DCI payload for transmission. A 24-bit cyclic redundancy check (CRC) may be calculated and appended to the (concatenated) DCI payload bits. The CRC may allow UEs receiving the GC-DCI to detect the presence of errors in the DCI payload bits. After the CRC is attached, the DCI payload bits and the CRC bits may be jointly encoded to protect the DCI against errors during transmission. The encoder output may be rate matched to fit some resources allocated for transmission of the GC-DCI and then broadcast for reception by the group of UEs. In certain aspects, the GC-DCI may be transmitted with one or more pilot signals to facilitate accurate demodulation and decoding of the GC-DCI by the receiving UEs. A pilot signal may refer to a known signal (e.g., its scheduled position within a slot is known to a receiver of the pilot), generally associated with a group of frequencies (e.g., subcarriers) that may be utilized for channel estimation. The group of UEs may monitor for the GC-DCI and the pilot signal(s). Upon detection, the UE may use the pilot signal(s) to determine a channel estimation and use the channel estimation to demodulate and decode the broadcasted packet (e.g., the GC-DCI). For example, the UE may decode the broadcasted packet to obtain the control information bits. A UE may keep only those control information bits intended for the UE and discard control information bits intended for other UEs in the group. This process of GC-DCI construction and communication is described in more detail below with respect to FIG. 5.

A number of resources used to transmit a GC-DCI may be based on a number of UEs, K, that the GC-DCI includes control information bits for, and a number of control information bits, b, included for each UE in the GC-DCI (e.g., which are concatenated). For example, a number a resources used to transmit a GC-DCI may be equal to (K*b). Thus, in cases where the GC-DCI carries control information for a large number of UEs, a large number of resources may be scheduled for the GC-DCI. As such, a large number of resources may need to be assigned for the PDCCH which, in some cases, may exhaust available resources to convey such control information.

Further, requiring UEs to detect and decode a broadcasted packet transmitted over a large number of time-frequency resources (e.g., a long packet) may increase the power consumption and/or complexity of each UE receiving the broadcasted packet. For example, instead of decoding a DCI that includes only control information bits intended for the UE (e.g., carried in a UE-specific DCI), the UE may need to perform channel estimation over a larger number resources and decode a longer packet, with a larger number of bits concatenated over the larger number of resources, to obtain the same control information intended for the UE. This additional power consumption and/or complexity of a UE to decode a GC-DCI may not be justified given the additional power consumption and/or complexity is used to obtain control information bits that the UE is expected to discard anyway. Put differently, the advantages of using GC-DCI instead of UE-specific DCI to convey the same control information (e.g., such as reducing pilot signaling overhead, increased coding gain, reduced false positive errors, etc.) may be realized at the cost of increased power consumption and/or complexity of each receiving UE of the GC-DCI.

In some cases, a network entity may need to send control information for only one UE in a group of UEs. To convey this information via a GC-DCI, the network entity may need to construct the longer packet GC-DCI (e.g., to be transmitted over a larger number of resources) although only control information bits for the single UE may be included in the packet. Specifically, the packet may need to further include indications for other UEs in the group, indicating that these UEs do not need to decode any bits in the transmitted packet. For example, a codepoint may indicate to each UE that the respective UE does not need to perform decoding after receiving the GC-DCI. As such, even when a small amount of control information bits needs to be transmitted, resource usage to transmit these bits may continue to be high. The use of resources to provide such indications may be considered wasteful and unnecessary when use of a UE-specific DCI to convey the same information may suffice (although one or more benefits of using GC-DCI may not be realized).

Further, for GC-DCI, beamforming techniques (e.g., techniques that use amplitude weighting and/or phase shift patterns across multiple antennas to focus transmission or reception of wireless signals in a particular spatial direction referred to as a beam), generally used to achieve spatial diversity and/or improve the reliability of communications (e.g., via directed communications), may not be utilized. For example, because the control information bits for multiple UEs are concatenated in a single message transmitted over multiple time-frequency resources, beamforming per UE may not be performed (based on the existence of only a single message), and thus, the aforementioned benefits may not be realized. Further, wireless coverage (e.g., the coverage of a wireless network represents how far wireless signals can be transmitted with sufficient signal strength) may be adversely affected without the use of beamforming techniques, especially for Frequency Range 2 (FR2) (e.g., between 24,250 MHz-71,000 MHz) and/or Frequency Range 3 (FR3) (e.g., between 7,125 MHz-24,250 MHz). For example, GC-DCI is generally broadcasted and may experience coverage issues.

Additionally, rate control techniques are used to determine the optimal bit rate for transmitting the GC-DCI to maximize throughput. An optimal bit rate determined for one UE may be different than an optimal bit rate determined for another UE; thus, throughput (or the amount of data that can be transmitted) may vary across UEs. When data (e.g., control information bits) for multiple UEs is concatenated in a GC-DCI however, the bit rate that may be used for transmission may be a bit rate that can be handled by all UEs. Thus, even though one or more UEs in the group of UEs receiving the GC-DCI may be able to handle a larger bit rate (e.g., to improve the overall performance of the network by reducing the likelihood of errors and/or re-transmissions, as well as increase the throughput of the network), a smaller bit rate may need to be used for transmission of the GC-DCI.

Accordingly, legacy GC-DCI designs suffer from the aforementioned technical deficiencies, which hamper their use for improved wireless communications performance.

Certain aspects described herein may overcome the aforementioned technical deficiencies associated with legacy GC-DCI designs and provide a technical benefit to the field of telecommunications. For example, aspects described herein provide sequence-based GC-DCI designs used to transmit control information for multiple UEs as a plurality of sequences combined in a superimposed signal (e.g., a composite signal) transmitted over a set of time-frequency resources. Each sequence included in the superimposed signal may be associated with a UE group intended to receive the GC-DCI.

As used herein, a UE group may include one or more UEs. In some cases, a network entity may create the different UE groups and assign different UE(s) to the different UE groups. In some cases, where a UE group consists of a single UE, the UE may itself constitute a UE group without assignment, by the network entity, of the UE to the UE group.

A sequence associated with a UE group may be based on a bit pattern corresponding to control information intended for the specific UE group. For example, control information included in a GC-DCI may include 2-bit power control commands for at least two UEs belonging to a same UE group. A first 2-bit power control command intended for the first UE may include bits “11.” A second 2-bit power control command intended for the second UE may include bits “00.” Thus, a sequence selected for this UE group, and included in the GC-DCI, may be based on the bit pattern “0011,” e.g., a combination of the bits intended for the first UE and the second UE. The sequence may be selected from a set of sequences configured for the UE group. It is noted that code-division multiple access (CDMA) is a multiplexing technology that similarly allows multiple signals to occupy a single transmission channel for the optimization of bandwidth use. CDMA may use codes assigned to different users, to allow multiple users to communicate over one frequency simultaneously (e.g., at the same time), where the codes are separate from the underlying data to be transmitted, and instead may be used to modulate data. Different from CDMA, the sequences included in the superimposed signal (e.g., corresponding to GC-DCI), as described herein, may themselves be based on the underlying data intended for different groups of UEs.

A sequence selected for a UE group may be selected from a set of sequences assigned to the UE group. In certain aspects, the sequence sets associated with different UE groups may be orthogonal. For example, the set of sequences associated with a first UE group may be unique to the first UE group. In certain aspects, the sequence sets associated with different UE groups may be non-orthogonal. For example, the set of sequences associated with a first UE group may be common to at least one other UE group. As used herein, a sequence may be a complex number; thus, a set of sequences associated with a UE may include a set of complex numbers, which may be predefined in the wireless specifications. Example sequences may include Walsh sequences, Zadoff Chu sequences, etc.

Conveying control information to multiple UE groups via sequences combined in the superimposed signal allows for the conveyance of separate control information for multiple UE groups. Maintaining separation of the control information for different UE groups in the GC-DCI may provide significant technical advantages over legacy GC-DCI designs used to convey similar control information. For example, the sequence-based GC-DCI designs described herein may allow a network entity to employ multi-user beamforming techniques when transmitting the GC-DCI to multiple UE groups, thereby leveraging spatial diversity (e.g., send redundant streams of information in parallel along multiple spatial paths) and directed transmissions. For example, using multi-user beamforming techniques, each sequence combined in the superimposed signal may be beamformed and transmitted separately to a UE group associated with the sequence (e.g., UEs in a UE group intended to receive the sequence). As such, the quality and reliability of control channel communications between the network entity and UEs in the multiple UE groups may be improved.

As another example, the sequence-based GC-DCI designs described herein may help to achieve better spectral efficiency (e.g., improved bit rate for control channel communications). Increased spectral efficiency may be attributed to multiplexing different sequences for different UE groups on a same set of time-frequency resources to convey control information for the different UE groups.

As another example, the sequence-based GC-DCI designs described herein may better scale as the number of UEs, for which control information is to be conveyed, increases. For example, unlike legacy GC-DCI designs, the number of resources used for transmitting the GC-DCI is not a function of the number of UEs. Instead, due to the combination of sequences in a superimposed signal, the addition of new sequences to the signal, for additional UE groups, may not increase the number of resources needed for transmitting the signal.

Further, the sequence-based GC-DCI designs described herein may allow for reduced complexity and/or power consumption at UEs receiving the GC-DCI. For example, a UE receiving the GC-DCI may leverage low-complexity non-coherent detection algorithms to detect and recover only the sequence(s) intended for a UE group that the UE belongs to. Thus, the UE may not need to detect and/or decode control information included in the superimposed signal for other UE groups, which may help to reduce power consumption and/or complexity at the UE. Further, due to the superimposed design of the GC-DCI, the UE may need to perform channel estimation over the set of time-frequency resources, which in some cases, may be less than the resources used for transmitting legacy GC-DCI.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

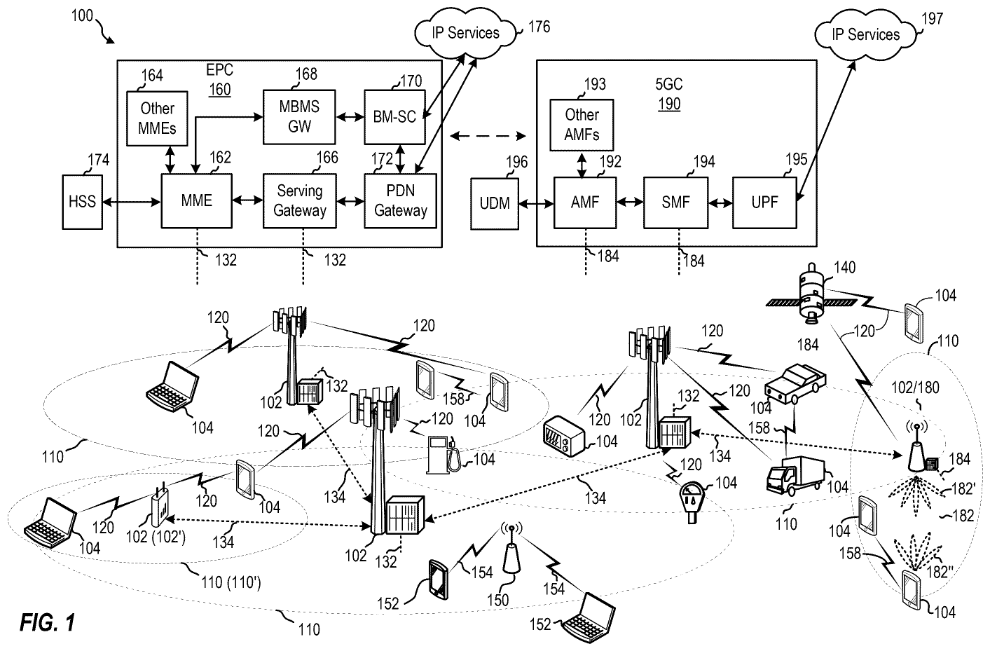

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

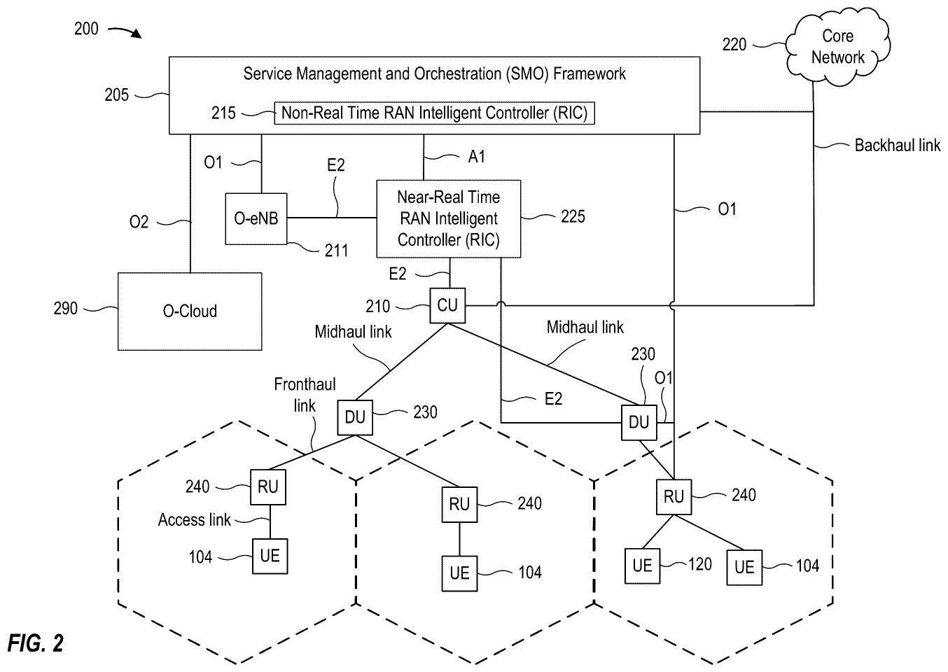

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

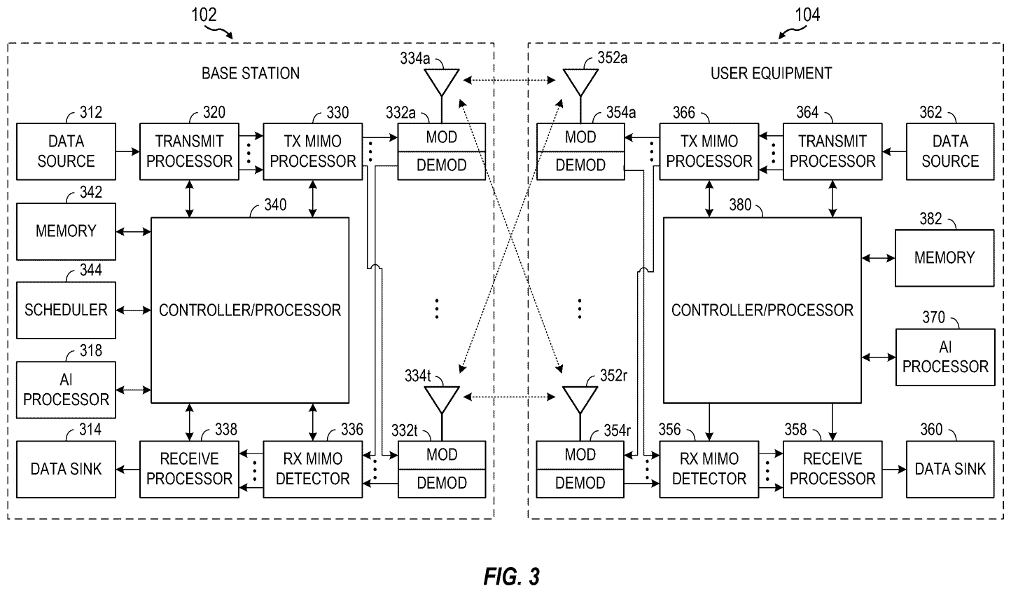

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

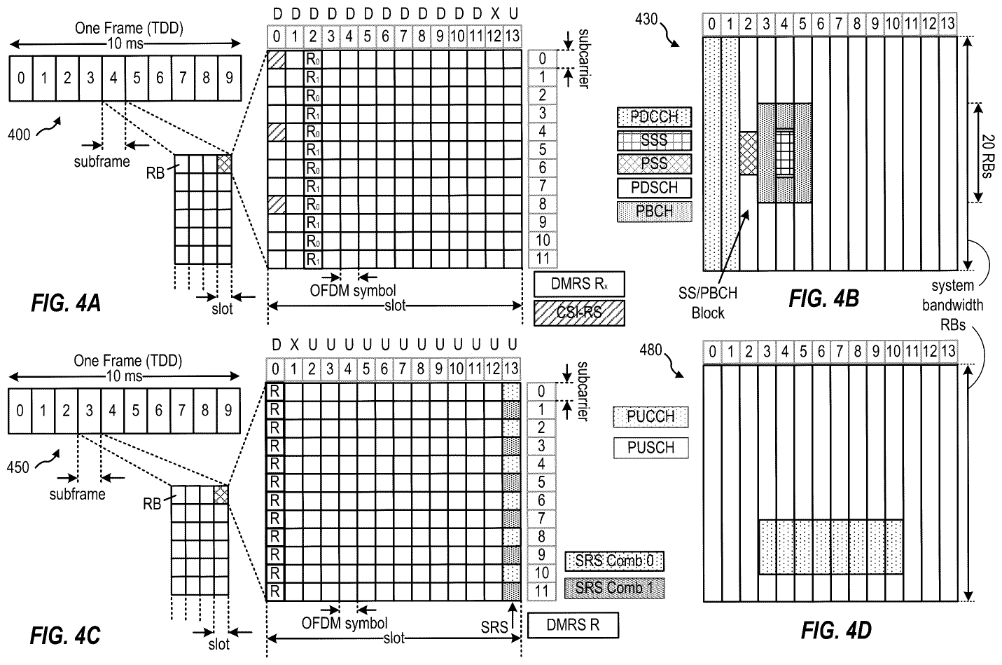

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to GC-DCI

One type of control information, such as carried by the PDCCH, is referred to as DCI. In certain aspects, the DCI may convey control information such as scheduling information for uplink and/or downlink data channels. In certain aspects, the DCI may include other control information such as (1) slot format indication(s), (2) wake-up indication(s), (3) secondary cell (SCell) dormancy indication(s), (4) power control indication(s), (5) preemption indication(s), and/or (5) cancellation indication(s), to name a few. A slot format indication may define which symbols are used for uplink, downlink, and/or sidelink within a specific slot. A wake-up indication may be used to indicate to a node, such as a UE, to wake up and begin monitoring for data sent to the node. As such, a wake-up indication may be a power saving mechanism used to help save power at the node by enabling a main receiver of the node to remain in a low power, sleep state until data intended for the UE is to be transmitted. An SCell dormancy indication may be another type of power saving mechanism used to indicate dormancy/non-dormancy behavior for SCell(s). A power control indication may be a transmit power control (TPC) command used to mitigate path loss and/or reduce interference. For example, a TPC may be used to dynamically control uplink transmit power (e.g., PUCCH, PUSCH, physical random access channel (PRACH), and/or sounding reference signal (SRS) transmit power). A preemption indication or a cancellation indication may indicate resource(s) that can no longer be used for downlink or uplink communication, respectively, by a node receiving the indication.

In certain aspects, the control information conveyed via a DCI may be intended for one UE (e.g., in a UE-specific DCI). In certain other aspects, the control information conveyed via a DCI may be intended for a group of UEs (e.g., in a GC-DCI). For example, the control information (e.g., in a GC-DCI), intended for the group of UEs, may be conveyed in a common PDCCH that is monitored by the group of UEs.

A sequence of processing steps may occur to generate a group common PDCCH payload (e.g., a GC-DCI) for transmission. FIG. 5 depicts an example process for GC-DCI construction and transmission to a group of UEs, such as UEs 504-1 through 504-k (e.g., where k is an integer greater than one) (collectively referred to herein as “UEs 504” and individually referred to herein as “UE 504”). Each UE 504 may be an example of UE 104 depicted and described with respect to FIGS. 1 and 3.

As shown in FIG. 5, control information bits, intended for UEs 504, may be concatenated to construct a GC-DCI payload 510. For example, control information bits, w₁, intended for UE 504-1, control information bits, w₂, intended for UE 504-2, control information bits, w₃, intended for UE 504-3, and other control information bits for other UE(s) up to UE 504-k (e.g, control information bits, wₖ) may be concatenated to construct GC-DCI payload 510.

The control information bits associated with each UE 504 may comprise a small number of bits. As an illustrative example, in certain aspects, GC-DCI payload 510 may be used for the transmission of a group of TPC commands for UEs 504 (e.g., where the GC-DCI constructed has a DCI format 2_2 or a DCI format 2_3). Thus, control information bits, w₁, may include a first 2-bit TPC command for UE 504-1, control information bits, w₂, may include a second 2-bit TPC command for UE 504-2, control information bits, w₃, may include a third 2-bit TPC command for UE 504-3, and so forth. Thus, the total number of bits included in GC-DCI payload 510 may be equal to (2 bits*Number of UEs 504). For example, if GC-DCI payload 510 is used for the transmission of a group of five TPC commands to five UEs 504, then GC-DCI payload may include a total of ten bits (e.g., 2 bits*5 UEs 504=10 bits).

As another illustrative example, in certain aspects, GC-DCI payload 510 may be used for the transmission of a group of downlink preemption indications (DLPIs) for UEs 504 (e.g., where the GC-DCI constructed has a DCI format 2_1). The DLPIs may notify each UE 504 about PRB(s) and OFDM symbol(s) where the respective UE 504 may assume no transmission is intended for the respective UE 504. Thus, control information bits [w₁, w₂, w₃, . . . wₖ] may each include a 14-bit DPLI intended for one of UEs 504-1 through 504-k. Similarly, GC-DCI payload 510 may be used for the transmission of a group of uplink cancellation indications (UCLIs) to indicate a plurality of resources where uplink transmission is not permitted by UEs 504.

As another illustrative example, in certain aspects, GC-DCI payload 510 may be used for the transmission of a group of wake-up indications for UEs 504 (e.g., where the GC-DCI constructed has a DCI format 2_6). For example, control information bits [w₁, w₂, w₃, . . . wₖ] may each include a 1-bit wake-up indication intended for one of UEs 504-1 through 504-k. A wake-up indication represented by bit “0” may indicate that the UE 504 receiving the wake-up indication is not to wake up. On the other hand, a wake-up indication represented by bit “1” may indicate that the UE 504 receiving the wake-up indication is to wake up because there is data to receive.

As another illustrative example, in certain aspects, GC-DCI payload 510 may be used for the transmission of a group of Scell dormancy indications for UEs 504 (e.g., where the GC-DCI constructed has a DCI format 2_6). For example, control information bits [w₁, w₂, w₃, . . . wₖ] may each include a 0-bit, 1-bit, 2-bit, 3-bit, 4-bit, or 5-bit Scell dormancy indication, intended for one of UEs 504-1 through 504-k. A 0-bit Scell dormancy indication may be used when RRC parameter dormancyGroupOutsideActive is not configured.

After concatenating the control information bits for each UE 504 to generate GC-DCI payload 510, a 24-bit CRC may be calculated and appended to GC-DCI payload 510, shown at 514. The CRC may allow the group of UEs 504 to detect the presence of errors after receiving and decoding GC-DCI payload 510 bits. After the CRC is attached, one or more of the CRC bits may be masked with an RNTI common to the group of UEs 504 (not shown in FIG. 5). For example, one or more of the CRC bits may be scrambled by the RNTI such that only UEs 504 for which GC-DCI payload 510 is intended can descramble the CRC, indicating that GC-DCI payload 510 is for UEs 504. Based on descrambling the CRC, UEs 504 may decode GC-DCI payload 510 and receive the concatenated control information bits.

The GC-DCI payload 510 bits and the CRC bits make up the total bits included in the GC-DCI. At 516, channel coding may be performed. Channel coding, also referred to as channel encoding or forward error correction (FEC), may be used to protect the bits in the GC-DCI from channel noise and/or interference, and thus, enhance communication reliability. FEC may be accomplished by systematically adding redundant bits to the sequence of GC-DCI bits. These redundant bits may be referred to as an “error correcting code.” The error correcting code may allow for the detection and correction of bit error(s) in the GC-DCI when received by UEs 504. Example channel coding schemes may include Polar coding and low-density parity-check (LDPC) coding.

The channel coding output is a broadcast packet 518 that may be broadcast, at least to UEs 504, by network entity 502. For example, broadcast packet 518 may be rate matched (not shown in FIG. 5) to fit the available resources allocated for GC-DCI transmission in the time-frequency grid of the PDCCH, and then broadcast for reception by the group of UEs 504.

In certain aspects, to facilitate accurate demodulation and decoding of the GC-DCI (e.g., broadcast packet 518) at UEs 504, the GC-DCI is transmitted with one or more pilot signals. An example pilot signal may include a demodulation reference signal (DMRS). A UE 504 receiving the one or more pilot signals, transmitted along with the GC-DCI, may (1) use the pilot signal(s) to estimate channel coefficients by exploiting known properties of the pilot signal(s) and (2) then use the channel coefficients to extract control information bits from the GC-DCI. For example, transmission of the pilot signal(s) may help UEs 504 to accurately estimate channel conditions on a PDCCH for demodulating and/or decoding the GC-DCI.

One or more search spaces (e.g., common search space (CSS), UE-specific search space (USS), etc.) may be defined for each UE 504. Search spaces are generally sets of time-frequency resources where a communications device, such as each UE 504, may look for (e.g., monitor for) control information, including GC-DCI. Based on the monitoring, each UE 504 may receive the GC-DCI, and more specifically, broadcast packet 518. Further, each UE 504 may receive one or more pilot signals, which may be transmitted along with the GC-DCI (not shown in FIG. 5).

Each UE 504 may determine a channel estimate based on the pilot signal(s), and decode the entire broadcast packet 518 based at least in part on the channel estimate. Each UE 504 may use the RNTI common to the group of UEs 504 to unscramble the CRC bits. Further each UE 504 may use the unscrambled CRC bits to verify the integrity of the control information bits received at UE 504 in the GC-DCI. After verification, each UE 504 may obtain their respective control information bits. For example, UE 504-1 may obtain control information bits w₁ and discard control information bits w₂-wₖ. UE 504-1 may obtain control information bits w₂ and discard control information bits w₁ and w₃-wₖ. UEs 504-3 through 504-k may similarly obtain their respective control information bits and discard control information bits intended for other UEs 504.

The use of GC-DCI to convey control information to the group of UEs 504 beneficially improves wireless communication by at least reducing signaling overhead. For example, instead of transmitting the control information for each UE 504 in the group in separate DCIs (e.g., UE-specific DCIs), a single GC-DCI is sufficient to provide the same information. Network entity 502 sending a single GC-DCI, instead of multiple UE-specific DCIs, may reduce the number of pilot signals that need to be transmitted by network entity 502. For example, network entity 502 may transmit along with the single GC-DCI a set of pilot signals common to UEs 504. Each UE 504 may estimate the channel based on the common pilot signals to decode the GC-DCI. Reduced pilot signal transmissions may contribute to reduced signaling overhead in the wireless communications network.

Greater coding gain may also be achieved when using joint encoding for GC-DCI construction instead of encoding multiple UE-specific DCI to convey the same control information to UEs 504. Coding gain refers to the improvement in the quality or efficiency of a digital communication system achieved through the use of error-correcting codes or coding techniques. Coding gain represents the reduction in error probability or bit error rate that can be achieved by using coding schemes compared to a non-coded transmission. For example, as described above, constructing a GC-DCI includes concatenating control information bits intended for each UE 504 in a group of UEs. Concatenating control information bits results in a larger GC-DCI payload 510, or put differently, a payload with a larger number of bits when compared to a UE-specific DCI payload including control information bits for only a single UE 504. Using joint encoding to encode a larger payload may help to achieve greater coding gain. For example, a larger payload (e.g., longer code) may have a performance closer to Shannon's capacity limit.

Further, GC-DCI having a larger payload size may require the use of a bigger-bit size CRC to enable UEs 504 decoding the GC-DCI to detect the presence of errors. In general, an n-bit size CRC may have “missed detection” probability of 2⁻ⁿ. Thus, the use of a bigger-bit size CRC (e.g., larger number of n-bits) for the larger payload GC-DCI may result in a lower “missed detection” probability. Lowering the detection error probability may be important given it is directly related to the error performance of the overall transmission.

While use of GC-DCI may provide the aforementioned benefit(s) when conveying control information to multiple UEs, the use of GC-DCI is not without limitation. For example, as described in detail above, the GC-DCI design may (1) exhaust channel resources, especially in cases where the GC-DCI is used to transmit control information for a large number of UEs, (2) may result in resource waste, (3) may limit the throughput that can be achieved due to rate control techniques used, (4) may not allow for beamforming techniques to be used, which may reduce wireless coverage, and/or (5) may increase power consumption and/or complexity at UEs receiving the GC-DCI, to name a few.

Such technical deficiencies associated with GC-DCI may hamper their use for improved wireless communications performance.

### Aspects Related to Sequence-Based GC-DCI

Aspects described herein provide enhanced GC-DCI designs used to convey control information to multiple UEs. For example, a GC-DCI described herein may have a sequence-based design where multiple (e.g., two or more) sequences are multiplexed and transmitted together, as a superimposed signal, on a same set of time-frequency resources. The multiple sequences may be associated with multiple UE groups, where a UE group includes one or more UEs. More specifically, each sequence may be associated with one UE group intended to receive the GC-DCI. Each sequence may be based on a bit pattern corresponding to data carried in the GC-DCI for the respective UE group.

As an illustrative example, a GC-DCI may be used to convey 2-bit control information for a first UE, a second UE, a third UE, and a fourth UE (e.g., 8-bit payload for four total UEs). The first and second UEs may belong to a first UE group, and the third and fourth UEs may belong to a second UE group. A first sequence included in the GC-DCI may be selected (e.g., by a transmitter of the GC-DCI, such as a network entity) based on a 4-bit pattern corresponding to control information intended for the first UE and the second UE (e.g., 2-bits each). Further, a second sequence included in the GC-DCI may be selected (e.g., by the transmitter) based on a 4-bit pattern corresponding to control information intended for the third UE and the fourth UE (e.g., 2-bits each). The sequences may be multiplexed on a same set of time-frequency resources and transmitted as a superimposed signal to the four UEs. In certain aspects, the superimposed signal is a linear combination of the two sequences.

Conveying control information to multiple UEs via the superimposed signal is different than conveying control information to multiple UEs using a legacy GC-DCI design. For example, transmission of the superimposed signal, including multiple sequences, enables the transmitter to send separate control information (e.g., as separate control messages) to each UE group. By contrast, a legacy GC-DCI design may include a single control message (e.g., including concatenated control information bits) that is sent to multiple UEs, as described above. Further, when sending separate control information to each UE group (e.g., via the superimposed signal), the transmitter may not use joint encoding and/or joint CRC.

A UE (e.g., among the multiple UEs) receiving the GC-DCI may detect, among the sequences included in the GC-DCI, at least one sequence associated with a UE group that the UE belongs to. The UE may decode the sequence to obtain data for the UE group, and then further obtain data (e.g., control information bit(s) intended) for the specific UE within the data associated with the UE group. As such, the UE, receiving the GC-DCI, may only need to decode the sequence associated with the UE group that the UE belongs to, without decoding other sequence(s) included in the GC-DCI. Accordingly, the UE may only need to discard data for other UEs in the UE group, rather than for all other UEs receiving the GC-DCI. Put differently, each UE may only detect (e.g., via sequence detection) and decode a sequence associated with a UE group for which the respective UE belongs, without detecting and decoding sequence(s) associated with other UE group(s) and included in the GC-DCI. For detection and decoding, complexity at a UE decreases as the number of sequences that need to be detected and decoded by the UE decreases. For example, the UE may need to monitor less time-frequency resources to detect the sequence, rather than monitor multiple time-frequency resources to detect a larger packet with multiple sequences. Further, the UE may need to perform channel estimation over fewer resources to be able to decode the sequence, rather than perform channel estimation over a larger number of resources to decode multiple sequences. In some cases, power consumption at the UE may also be saved based on detecting and decoding only the sequence intended for a UE group associated with the UE.

### Example Signaling of Sequence-Based GC-DCI

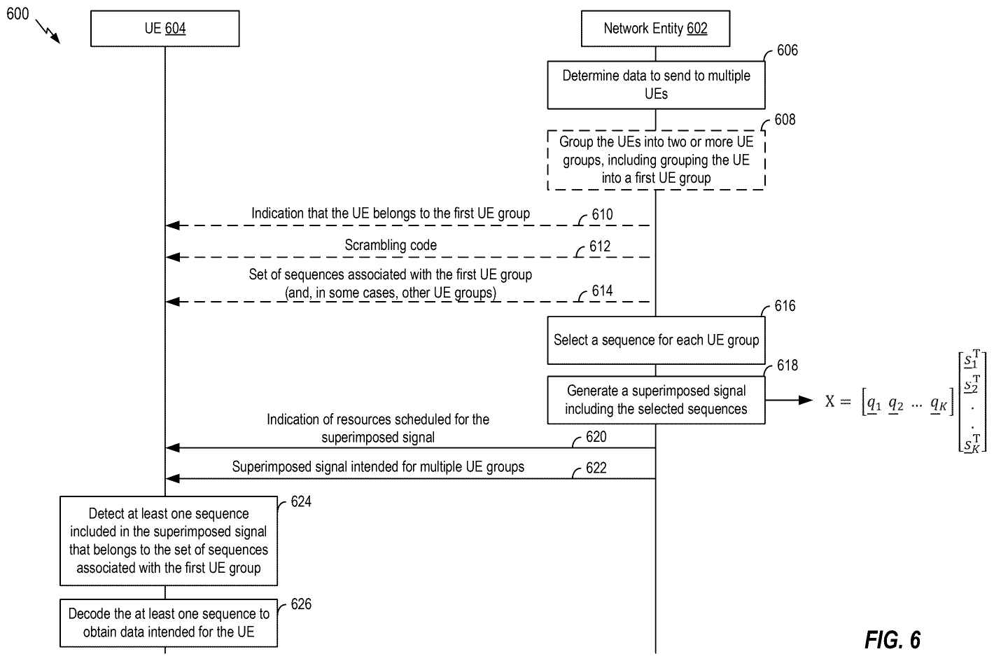

FIG. 6 depicts a process flow 600 for communications in a network between a network entity 602 and a UE 604. In certain aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

In certain aspects, process flow 600 is used to construct and transmit a sequence-based GC-DCI as a superimposed signal including a combination of multiple sequences associated with multiple UE groups. Each sequence included in the superimposed signal may be associated with a single UE group. A sequence associated with a UE group may be based on a bit pattern corresponding to data (e.g., control information) carried in the GC-DCI and intended for UE(s) in the UE group.

Process flow 600 begins, at 606, with network entity 602 determining data to send to multiple UEs (e.g., two or more UEs, including UE 604). More specifically, network entity 602 may determine data to send to each UE among the multiple UEs. The data may include control information. For example, the data to send to each UE may include a hybrid automatic repeat request (HARQ) indication for uplink communications; a TPC indication for uplink communications; a timing advance (TA) command; a preemption indication; a wakeup signal; a paging indication; and/or a discontinuous reception indication, to name a few. In certain aspects, network entity 602 determines to send data to one UE (e.g., a HARQ indication) that is different than data sent to a second UE (e.g., a TPC command).

As an illustrative example, network entity 602 may determine to send data (e.g., control information) to four UEs (e.g., UE1, UE2, UE3, and UE4). Network entity 602 may determine to send a first 2-bit TPC command to UE1, a second 2-bit TPC command to UE2, a third 2-bit TPC command to UE3, and a fourth 2-bit TPC command to UE4. Thus, at 606, network entity 602 may determine to send eight control information bits to four UEs.

Process flow 600 optionally proceeds, at 608, with network entity 602 grouping the multiple UEs into two or more UE groups. Each UE group may include one or more UEs. A first UE group may include UE 604. In certain aspects, network entity 602 assigns UE 604 to the first UE group with or without other UEs.

A number of UE groups created by network entity 602 may be based on various factors. In certain aspects, network entity 602 groups the multiple UEs into two or more UE groups based on their channel correlations. For example, UEs with channels that are more correlated may be assigned to the same UE group. In certain aspects, network entity 602 groups multiple UEs into two or more UE groups by grouping together UEs with channels having a same quality, path loss, and/or location. For example, network entity 602 may group together UEs with similar characteristics.

In certain aspects, network entity 602 does not group the multiple UEs into UE groups at 606. Instead, each “UE group” (as described below) is a group that includes only one UE among the multiple UEs. For example, each UE may belong to its own UE group without being explicitly assigned to the UE group by network entity 602.

Process flow 600 optionally proceeds, at 610, with network entity 602 sending, to UE 604, an indication that UE 604 belongs to the first UE group. In certain aspects, the indication is provided to UE 604 via radio resource control (RRC) signaling.

Process flow 600 optionally proceeds, at 612, with network entity 602 sending, to UE 604, an indication of a scrambling code uniquely associated with the first UE group. The scrambling code may be a RNTI unique associated with the first UE group. In certain aspects, the indication is provided to UE 604 via RRC signaling. As described in detail below, in certain aspects, UE 604 may use the scrambling code to obtain a sequence included in a superimposed signal that is intended for the first UE group.

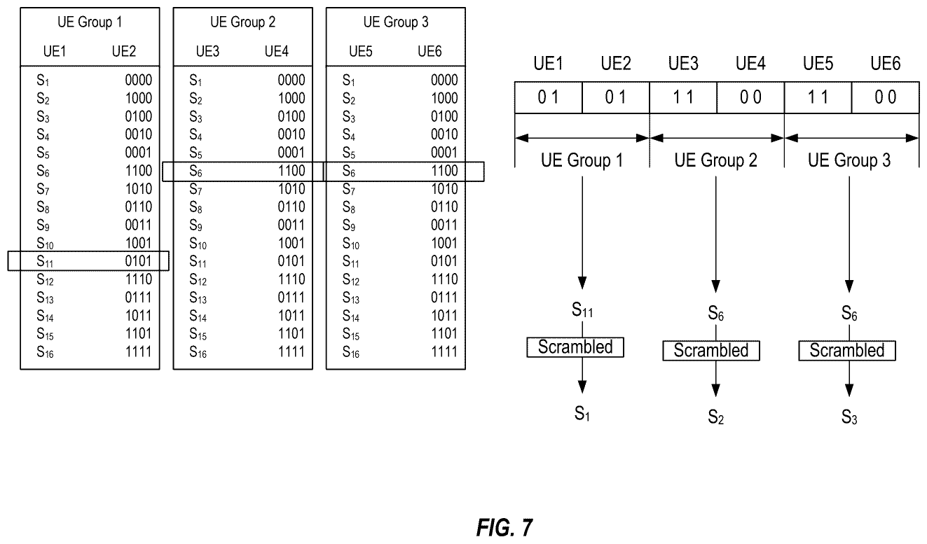

Process flow 600 optionally proceeds, at 614, with network entity 602 sending, to UE 604, a configuration of a set of sequences associated with the first UE group. For example, the configuration may indicate different sequences included in the set of sequences and associate the first UE group with each of those sequences in the set. In certain aspects, the configuration is provided to UE 604 via RRC signaling. Example configurations of sets of sequences for different UE groups is depicted and described with respect to FIG. 7.

In certain aspects, the configuration of the set of sequences comprises a sequence hopping pattern. For example, the set of sequences configured for UE 604 may be changing from transmission occasion to transmission occasion for better performance and/or randomization.

In certain aspects, the set of sequences associated with the first UE group is orthogonal. For example, the set of sequences associated with the first UE group may be unique to the first UE group. Put differently, the set of sequences associated with the first UE group may be different than the set of sequences associated with a second UE group, a third UE group, etc.

In certain other aspects, the set of sequences associated with the first UE group is non-orthogonal. In particular, the set of sequences associated with the first UE group is common to at least one other UE group. For example, the set of sequences associated with the first UE group may be the same set of sequences that are associated with at least a second UE group. In cases where the set of sequences associated with the first UE group is non-orthogonal, then transmission of the scrambling code, at 610, may be required. For example, as described in more detail below, non-orthogonal sequences included in a superimposed signal may be scrambled with a unique scrambling code of a UE group associated with the sequence. Accordingly, only the UE group using its unique scrambling code may be able to decode the sequence to obtain the data intended for the UE group. An example use case where UE groups are configured with a common set of sequences is described below with respect to FIG. 7.

Network entity 602 may determine whether the set of sequences associated with the first UE group is orthogonal or non-orthogonal. In certain aspects, network entity 602 makes this determination based on one or more system parameters, such as a number of UE groups that exist (e.g., optionally created at 608), a total number of control information bits to send to UEs in each UE group, and/or a number of time-frequency resources to assign for GC-DCI.

In certain other aspects, instead of receiving the configuration of the set of sequences at 614, UE 604 may be pre-configured with the set of sequences associated with the first UE group. For example, the multiple UEs, including UE 604, may be pre-configured with a common set of sequences. As another example, only UE 604 may be pre-configured with the set of sequences. In some cases, the pre-configured set of sequences may be unique to the first UE group, which may include only UE 604.

In certain aspects, in addition to sending the set of sequences associated with the first UE group, network entity 602 may also send, at 612 to UE 604, an indication of other set(s) of sequences associated with other UE group(s). For example, network entity 602 may send the other set(s) of sequences to enable UE 604 to perform multi-user detection (e.g., successive interference cancellation (SIC), which is the ability of a receiver, such as UE 604, to receive two or more sequences concurrently (that otherwise cause collision)). For multi-user detection, UE 604 may detect interfering sequences intended for other UE groups, and included in a superimposed signal. Based on the detection, UE 604 may cancel the interference. In certain aspects, UE 604 is configured to perform multi-user detection.

In certain aspects, a number of sequences included in the set of sequences associated with the first UE group is based on a number of bits (z) represented by one sequence in the set of sequences. For example, a number of sequences included in the set of sequences associated with the first UE group may be equal to (2^{z}). The number of bits (z) represented by one sequence may be equal to a number of control bits corresponding to UEs in the first group, which have been concatenated.

As an illustrative example, the first UE group may include two UEs, including UE 604. At 606, network entity 602 may determine to send a first 2-bit TPC command to UE 604 and a second 2-bit TPC command to the other UE in the group. Thus, control information bits for the first group, when concatenated, may include a total of four bits (e.g., 2-bit TPC command+2-bit TPC command). Accordingly, each sequence associated with the first UE group may be based on a total of four bits. Thus, a number of sequences included in the set of sequences associated with the first UE group may be equal to (2^{z}=2⁴=16 sequences). The sixteen sequences may include a first sequence associated with the 4-bit bit pattern [0000] where the first two bits in the first sequence correspond to UE 604 and the second two bits in the first sequence correspond to the other UE. The remaining fifteen other sequences may include sequences associated with bit patterns [0001] through [1111], such as the sequences shown in FIG. 7.

Process flow 600 then proceeds, at 616 with network entity 602 selecting a sequence for each UE group. For example, network entity 602 may pick a number of sequences equal to the number of UE groups. As described herein, network entity 602 may select a sequence for a UE group based on a respective bit pattern corresponding to data (e.g., control information) to be sent to UEs in the specific UE group. As an illustrative example, if two UE groups exist, then network entity 602 may select two sequences at 616. One of the two sequences may be selected as a sequence from a set of sequences associated with the first UE group. The sequence selected may be based on a bit pattern corresponding to data that is to be sent to UE(s) in the first UE group. The other of the two sequences may be selected as a sequence from a set of sequences associated with the second UE group. The other sequence selected may be based on a bit pattern corresponding to data that is to be sent to UE(s) in the second UE group.

Process flow 600 proceeds, at 618, with network entity 602 generating a superimposed signal including the selected sequences. In certain aspects, network entity 602 generates a superimposed signal that is a linear combination of the selected sequences associated with each UE group. In certain aspects, the selected sequences included in the superimposed signal are each weighted by a respective precoder coefficient (e.g., amplitude and/or phase coefficients) corresponding to a UE group associated with the sequence. For example, the superimposed signal (X) may take the form of:

$$X = [ {\underline{q}}_{1} {\underline{q}}_{2} ... {\underline{q}}_{K} ] [ \begin{matrix}\begin{matrix}\begin{matrix}{\underline{s}}_{1}^{T} \\ \begin{matrix}{\underline{s}}_{2}^{T} \\ .\end{matrix}\end{matrix} \\ .\end{matrix} \\ {\underline{s}}_{K}^{T}\end{matrix} ]$$

where K represents the number of UE groups, qᵢ is the precoder coefficient associated with a UE group i, and sᵢ represents the sequence selected for a UE group i based on the control information intended for the UE group i. Specifically, precoding is a generalized beamforming scheme that may be used to support multi-layer transmission in a MIMO system. Using precoding, multiple streams may be transmitted from transmit antennas at a transmitter with appropriate weighting per antenna such that throughput is maximized at a receiver. As used herein, precoding coefficients, qᵢ, may be applied by a precoder to adjust the weighting per antenna for beamformed communications to each UE group i. Further, in the superimposed signal (X) equation, each [q₁ q₂ . . . q_{K}] and

$$[ {\underline{s}}_{1}^{T} , {\underline{s}}_{2}^{T} , ... {\underline{s}}_{K}^{T} ]$$

may represent column vectors.

At 620, network entity 602 sends, to UE 604, an indication of a set of time-frequency resources scheduled for the superimposed signal. The indication of the set of time-frequency resources may indicate a number of OFDM symbols in the time domain, a number of RBs in the frequency domain, etc. that are scheduled for transmission of the superimposed signal (e.g., from network entity 602 to UE 604).

At 622, network entity 602 sends, to UE 604, the superimposed signal over the scheduled set of time-frequency resources. The superimposed signal may correspond to a GC-DCI. As described above, the superimposed signal may include a combination of the sequences selected by network entity 602 at 616. Each sequence of the superimposed signal may be beamformed and transmitted separately to its corresponding UE group (e.g., the UE group intended to receive the control information associated with the particular sequence).

In certain aspects, the sequence intended for the first UE group and included in the superimposed signal may be quasi co-located (QCLed) with a reference signal (e.g., a channel state information reference signal (CSI-RS) or a physical broadcast channel (PBCH)). However, the transmit power of the sequence may be different from that of the CSI-RS or PBCH, due to the downlink multi-user multiplexing via the superimposed signal.

At 624, UE 604 detects at least one sequence included in the superimposed signal that belongs to the set of sequences associated with the first UE group. UE 604 may detect the at least one sequence among the plurality of sequences included in the superimposed signal via sequence detection. For sequence detection, UE 604 may only need to be aware of the set of sequences assigned to the first UE group (e.g., which UE 604 belong), as UE 604 only needs to detect the sequence included in the superimposed signal that is intended for the first UE group. In certain aspects, UE 604 employs non-coherent detection techniques to detect the sequence intended for the first UE group (e.g., the group that UE 604 is associated with and/or assigned to). With non-coherent detection, UE 604 may not need to have prior knowledge of the channel impulse response, unlike coherent detection. Thus, non-coherent detection may be less complex than coherent detection.

In certain aspects, the superimposed signal (Y) received at UE 604 (e.g., the k-th UE in the following equation) may take the form of:

$$Y = {H}_{k} X + W$$

where Hₖ is the multiple-input-multiple-output (MIMO) channel between UE k (e.g., UE 604) and network entity 602 and W represents additive noise.

At 626, UE 604 decodes the at least one sequence to obtain data intended for UE 604. In some cases, the at least one sequence includes data for UE 604 and another UE (e.g., the first UE group includes two UEs). Thus, UE 604 may discard the data intended for the other UE in the first UE group and keep the data intended for UE 604. In certain aspects, there may be an index of UE 604 in the first UE group such that UE 604 knows which bits (e.g., such as the first two bits of data) are intended for UE 604 (and other bits of the data may be intended for other UE(s) in the first group of UEs).

Note that the process flow illustrated in FIG. 6 is described herein to facilitate an understanding of using a sequence-based GC-DCI to convey control information for multiple UEs, and aspects of the present disclosure may be performed in various manners via alternative or additional signaling and/or operations. In certain aspects, the operations and/or signaling of FIG. 6 may occur in an order different from that described or depicted, and various actions, operations, and/or signaling may be added, omitted, or combined.

FIG. 7 depicts example sequence selection for multiple UE groups. For example, the sequence selection shown in FIG. 7 may be an example of sequence selection at 616 in process flow 600 of FIG. 6.

As shown in FIG. 7, three UE groups may exist, include UE group 1, UE group 2, and UE group 3. UE group 1 may include UE1 and UE2. UE group 2 may include UE3 and UE4. UE group 3 may include UE5 and UE6.

The set of sequences configured for each UE group may be common among the UE groups. Put differently, the set of sequences may be non-orthogonal such that a same set of sequences is configured for UE group 1, UE group 2, and UE group 3.

In this example, 2-bit control information may be sent to each UE. Thus, a number of bits associated with each sequence may be equal to four (e.g., (2 UEs per UE group)*(2-bits per UE)=4 total bits concatenated and associated with each sequence). Further, a number of sequences included in the common set of sequences may be equal to sixteen (e.g., 2⁴=16 sequences). The example sixteen sequences (S₁-S₁₆) are shown in FIG. 7.

2-bit control information sent to UE1 includes bits “01” and 2-bit control information sent to UE2 includes bits “01.” Thus, control information bits transmitted for UE group 1 may include bits “0101.” Bits “0101” correspond to sequence 11 (S₁₁).

2-bit control information sent to UE3 includes bits “11” and 2-bit control information sent to UE4 includes bits “00.” Thus, control information bits transmitted for UE group 2 may include bits “1100.” Bits “1100” correspond to sequence 6 (S₆).

Similarly, 2-bit control information sent to UE5 includes bits “11” and 2-bit control information sent to UE6 includes bits “00.” Thus, control information bits transmitted for UE group 3 may also include bits “1100.” Bits “1100” correspond to sequence 6 (S₆).

In this example, because a common set of sequences is used across UE groups, a same sequence may be selected for two different UE groups (e.g., sequence 6 is selected for both UE group 2 and UE group 3). To differentiate the sequence for UE group 2 from the UE sequence for UE group 3 in the superimposed signal, each sequence may be scrambled with a scrambling code unique to each UE group. For example, sequence 11 may be scrambled with a first scrambling code unique to UE group 1 to generate a first sequence, S₁, that may be included in the superimposed signal for UE group 1. Sequence 6 may be scrambled with a second scrambling code unique to UE group 2 to generate a second sequence, S₂, that may be included in the superimposed signal for UE group 2. Lastly, sequence 6 may be scrambled with a third scrambling code unique to UE group 3 to generate a third sequence, S₃, that may be included in the superimposed signal for UE group 3.

### Example Operations

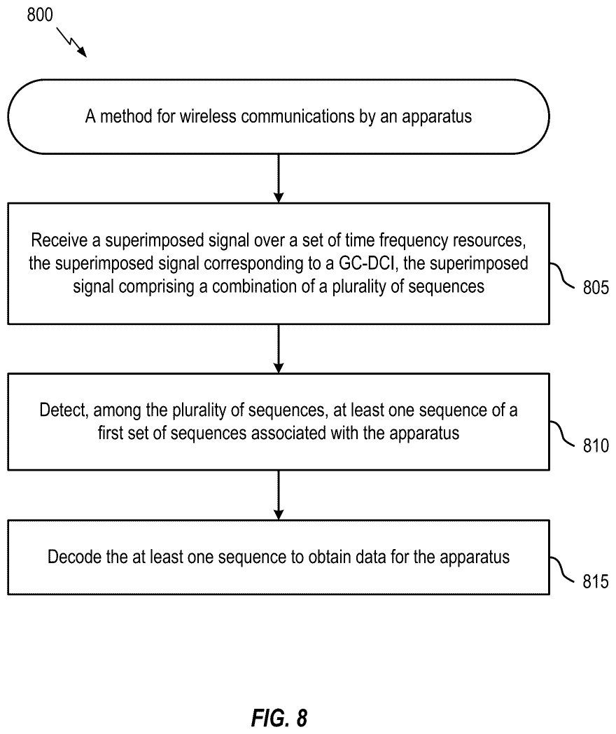

FIG. 8 shows a method 800 for wireless communications by an apparatus, such as UE 104 of FIGS. 1 and 3.

Method 800 begins at block 805 with receiving a superimposed signal over a set of time frequency resources, the superimposed signal corresponding to a GC-DCI, the superimposed signal comprising a combination of a plurality of sequences.

Method 800 then proceeds to block 810 with detecting, among the plurality of sequences, at least one sequence of a first set of sequences associated with the apparatus.

Method 800 then proceeds to block 815 with decoding the at least one sequence to obtain data for the apparatus.

In one aspect, each sequence of the plurality of sequences is based on a respective bit pattern corresponding to data carried in the GC-DCI.

In one aspect, the superimposed signal is a linear combination of the plurality of sequences.

In one aspect, the superimposed signal comprises the plurality of sequences, each weighted by a respective precoder coefficient corresponding to a UE group associated with the sequence.

In one aspect, the first set of sequences is common to a plurality of UE groups comprising a first UE group that includes the apparatus; and the at least one sequence is scrambled by a scrambling code common to the first UE group.

In one aspect, the first UE group consists of the apparatus.

In one aspect, the first UE group comprises a plurality of UEs.

In one aspect, the at least one sequence comprises a first sequence based on the data for the apparatus and data for a second UE.

In one aspect, method 800 further includes receiving a configuration of the scrambling code.

In one aspect, method 800 further includes receiving signaling indicating that the apparatus belongs to the first UE group.

In one aspect, the plurality of sequences are associated with a plurality of UE groups comprising a first UE group that includes the apparatus; and the first set of sequences is uniquely associated with the first UE group.

In one aspect, method 800 further includes receiving a configuration of the first set of sequences.

In one aspect, the configuration of the first set of sequences comprises a sequence hopping pattern.

In one aspect, method 800 further includes receiving an indication of other sets of sequences associated with other UE groups in the plurality of UE groups.

In one aspect, the apparatus is associated with the first UE group based on one or more characteristics of a channel between the apparatus and a network entity.

In one aspect, method 800 further includes receiving signaling indicating that the apparatus belongs to the first UE group.

In one aspect, a number of sequences included in the first set of sequences is based on a number of bits represented by one sequence of the first set of sequences.

In one aspect, block 810 includes performing non-coherent detection to detect the at least one sequence.

In one aspect, method 800 further includes receiving an indication of the set of time frequency resources scheduled for the superimposed signal.

In one aspect, the data comprises at least one of: a hybrid automatic repeat request indication for uplink communications; a transmit power control indication for the uplink communications; a timing advance command; a preemption indication; a wakeup signal; a paging indication; or a discontinuous reception indication.

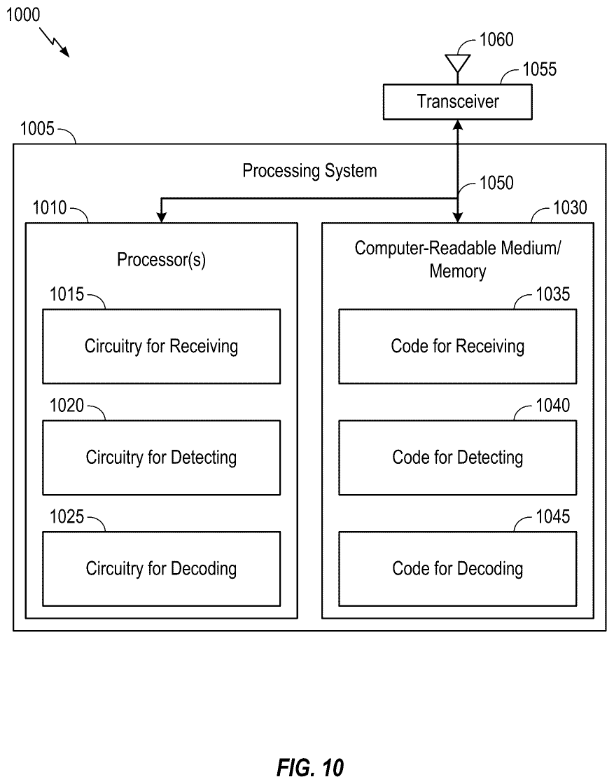

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

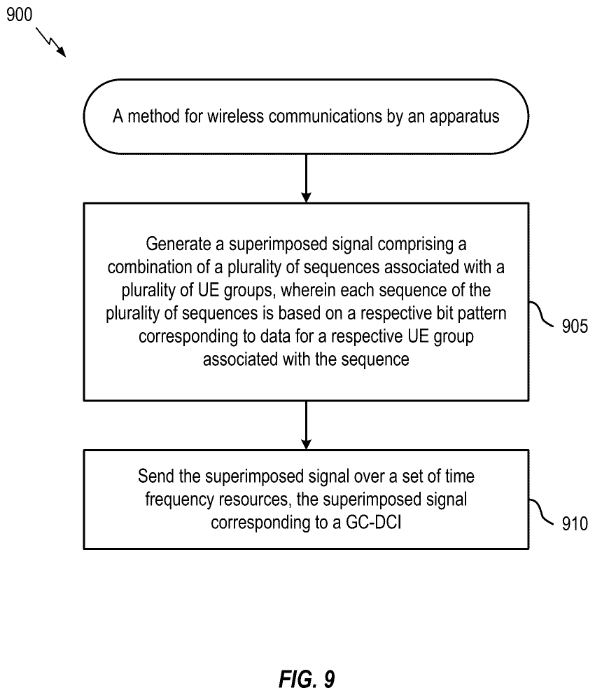

FIG. 9 shows a method 900 for wireless communications by an apparatus, such as BS 102 of FIGS. 1 and 3, or a disaggregated base station as discussed with respect to FIG. 2.

Method 900 begins at block 905 with generating a superimposed signal comprising a combination of a plurality of sequences associated with a plurality of UE groups, wherein each sequence of the plurality of sequences is based on a respective bit pattern corresponding to data for a respective UE group associated with the sequence.

Method 900 then proceeds to block 910 with sending the superimposed signal over a set of time frequency resources, the superimposed signal corresponding to a GC-DCI.

In one aspect, the superimposed signal is a linear combination of the plurality of sequences.

In one aspect, the superimposed signal comprises the plurality of sequences, each weighted by a respective precoder coefficient corresponding to the respective UE group associated with the sequence.

In one aspect, the plurality of sequences are associated with a first set of sequences common to the plurality of UE groups; and each sequence of the plurality of sequences is scrambled by a scrambling code common to the respective UE group associated with the sequence.

In one aspect, at least one of the plurality of UE groups consists of a single UE.

In one aspect, at least one of the plurality of UE groups comprises a plurality of UEs.

In one aspect, at least one sequence of the plurality of sequences comprises the data for a first UE and a second UE belonging to the respective UE group associated with the sequence.

In certain aspects, method 900 further includes sending a configuration of each scrambling code.

In certain aspects, method 900 further includes sending signaling, to a UE, indicating that the UE belongs to a first UE group of the plurality of UE groups.

In one aspect, the plurality of UE groups comprise a first UE group; a first set of sequences is uniquely associated with the first UE group; and the first set of sequences comprises a first sequence of the plurality of sequences.

In certain aspects, method 900 further includes sending, to one or more UEs in the first UE group, a configuration of the first set of sequences.

In one aspect, the configuration of the first set of sequences comprises a sequence hopping pattern.

In certain aspects, method 900 further includes sending, to the one or more UEs in the first UE group, an indication of other sets of sequences associated with other UE groups in the plurality of UE groups.

In certain aspects, method 900 further includes grouping a plurality of UEs into the plurality of UE groups based on one or more characteristics of a channel between the apparatus and each UE of the plurality of UEs.

In one aspect, a number of sequences included in the first set of sequences is based on a number of bits represented by one sequence of the first set of sequences.

In certain aspects, method 900 further includes sending an indication of the set of time frequency resources scheduled for the superimposed signal.

In one aspect, the data comprises at least one of: a hybrid automatic repeat request indication for uplink communications; a transmit power control indication for the uplink communications; a timing advance command; a preemption indication; a wakeup signal; a paging indication; or a discontinuous reception indication.

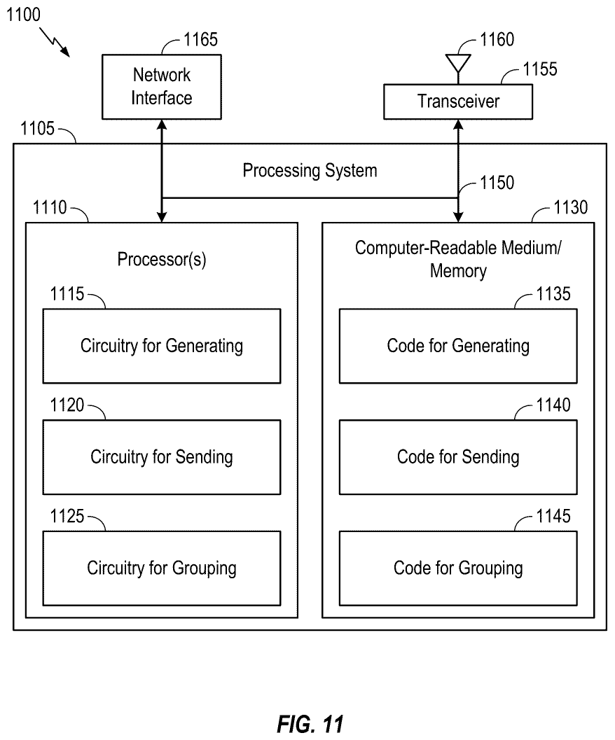

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1055 (e.g., a transmitter and/or a receiver). The transceiver 1055 is configured to transmit and receive signals for the communications device 1000 via an antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code), including code 1035-1045, that when executed by the one or more processors 1010, enable and cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1030 stores code for receiving 1035, code for detecting 1040, and code for decoding 1045. Processing of the code 1035-1045 may enable and cause the communications device 1000 to perform the method 800 described with respect to FIG. 8, or any aspect related to it.

The one or more processors 1010 include circuitry configured to implement (e.g., execute) the code (e.g., executable instructions) stored in the computer-readable medium/memory 1030, including circuitry for receiving 1015, circuitry for detecting 1020, and circuitry for decoding 1025. Processing with circuitry 1015-1025 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1055 and/or antenna 1060 of the communications device 1000 in FIG. 10, and/or one or more processors 1010 of the communications device 1000 in FIG. 10. Means for communicating, receiving or obtaining may include the transceivers 354, antenna(s) 352, receive processor 358, AI processor 370, and/or controller/processor 380 of the UE 104 illustrated in FIG. 3, transceiver 1055 and/or antenna 1060 of the communications device 1000 in FIG. 10, and/or one or more processors 1010 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code), including code 1135-1145, that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1130 stores code for generating 1135, code for sending 1140, and code for grouping 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1130, including circuitry for generating 1115, circuitry for sending 1120, and circuitry for grouping 1125. Processing with circuitry 1115-1125 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1155, antenna 1160, and/or network interface 1165 of the communications device 1100 in FIG. 11, and/or one or more processors 1110 of the communications device 1100 in FIG. 11.

### EXAMPLE CLAUSES

Implementation examples are described in the following numbered clauses:

Clause 1: A method for wireless communications by an apparatus comprising: receiving a superimposed signal over a set of time frequency resources, the superimposed signal corresponding to a GC-DCI, the superimposed signal comprising a combination of a plurality of sequences; detecting, among the plurality of sequences, at least one sequence of a first set of sequences associated with the apparatus; and decoding the at least one sequence to obtain data for the apparatus.

Clause 2: The method of Clause 1, wherein each sequence of the plurality of sequences is based on a respective bit pattern corresponding to data carried in the GC-DCI.

Clause 3: The method of any one of Clauses 1-2, wherein the superimposed signal is a linear combination of the plurality of sequences.

Clause 4: The method of any one of Clauses 1-3, wherein the superimposed signal comprises the plurality of sequences, each weighted by a respective precoder coefficient corresponding to a UE group associated with the sequence.

Clause 5: The method of any one of Clauses 1-4, wherein: the first set of sequences is common to a plurality of UE groups comprising a first UE group that includes the apparatus; and the at least one sequence is scrambled by a scrambling code common to the first UE group.

Clause 6: The method of Clause 5, wherein the first UE group consists of the apparatus.

Clause 7: The method of Clause 5, wherein the first UE group comprises a plurality of UEs.

Clause 8: The method of Clause 7, wherein the at least one sequence comprises a first sequence based on the data for the apparatus and data for a second UE.

Clause 9: The method of Clause 5, further comprising: receiving a configuration of the scrambling code.

Clause 10: The method of Clause 5, further comprising: receiving signaling indicating that the apparatus belongs to the first UE group.

Clause 11: The method of any one of Clauses 1-10, wherein: the plurality of sequences are associated with a plurality of UE groups comprising a first UE group that includes the apparatus; and the first set of sequences is uniquely associated with the first UE group.

Clause 12: The method of Clause 11, further comprising: receiving a configuration of the first set of sequences.

Clause 13: The method of Clause 12, wherein the configuration of the first set of sequences comprises a sequence hopping pattern.

Clause 14: The method of Clause 12, further comprising: receiving an indication of other sets of sequences associated with other UE groups in the plurality of UE groups.

Clause 15: The method of Clause 11, wherein: the apparatus is associated with the first UE group based on one or more characteristics of a channel between the apparatus and a network entity.

Clause 16: The method of Clause 11, further comprising: receiving signaling indicating that the apparatus belongs to the first UE group.

Clause 17: The method of any one of Clauses 1-16, wherein a number of sequences included in the first set of sequences is based on a number of bits represented by one sequence of the first set of sequences.

Clause 18: The method of any one of Clauses 1-17, wherein detecting the at least one sequence comprises performing non-coherent detection to detect the at least one sequence.

Clause 19: The method of any one of Clauses 1-18, further comprising receiving an indication of the set of time frequency resources scheduled for the superimposed signal.

Clause 20: The method of any one of Clauses 1-19, wherein the data comprises at least one of: a hybrid automatic repeat request indication for uplink communications; a transmit power control indication for the uplink communications; a timing advance command; a preemption indication; a wakeup signal; a paging indication; or a discontinuous reception indication.

Clause 21: A method for wireless communications by an apparatus comprising: generating a superimposed signal comprising a combination of a plurality of sequences associated with a plurality of UE groups, wherein each sequence of the plurality of sequences is based on a respective bit pattern corresponding to data for a respective UE group associated with the sequence; and sending the superimposed signal over a set of time frequency resources, the superimposed signal corresponding to a GC-DCI.

Clause 22: The method of Clause 21, wherein the superimposed signal is a linear combination of the plurality of sequences.

Clause 23: The method of any one of Clauses 21-22, wherein the superimposed signal comprises the plurality of sequences, each weighted by a respective precoder coefficient corresponding to the respective UE group associated with the sequence.

Clause 24: The method of any one of Clauses 21-23, wherein: the plurality of sequences are associated with a first set of sequences common to the plurality of UE groups; and each sequence of the plurality of sequences is scrambled by a scrambling code common to the respective UE group associated with the sequence.

Clause 25: The method of Clause 24, wherein at least one of the plurality of UE groups consists of a single UE.

Clause 26: The method of Clause 24, wherein at least one of the plurality of UE groups comprises a plurality of UEs.

Clause 27: The method of Clause 26, wherein at least one sequence of the plurality of sequences comprises the data for a first UE and a second UE belonging to the respective UE group associated with the sequence.

Clause 28: The method of Clause 24, further comprising: sending a configuration of each scrambling code.

Clause 29: The method of any one of Clauses 21-28, further comprising: sending signaling, to a UE, indicating that the UE belongs to a first UE group of the plurality of UE groups.

Clause 30: The method of any one of Clauses 21-29, wherein: the plurality of UE groups comprise a first UE group; a first set of sequences is uniquely associated with the first UE group; and the first set of sequences comprises a first sequence of the plurality of sequences.

Clause 31: The method of Clause 30, further comprising: sending, to one or more UEs in the first UE group, a configuration of the first set of sequences.

Clause 32: The method of Clause 31, wherein the configuration of the first set of sequences comprises a sequence hopping pattern.

Clause 33: The method of Clause 31, further comprising: sending, to the one or more UEs in the first UE group, an indication of other sets of sequences associated with other UE groups in the plurality of UE groups.

Clause 34: The method of Clause 30, further comprising: grouping a plurality of UEs into the plurality of UE groups based on one or more characteristics of a channel between the apparatus and each UE of the plurality of UEs.

Clause 35: The method of Clause 30, wherein a number of sequences included in the first set of sequences is based on a number of bits represented by one sequence of the first set of sequences.

Clause 36: The method of any one of Clauses 21-35, further comprising sending an indication of the set of time frequency resources scheduled for the superimposed signal.

Clause 37: The method of any one of Clauses 21-36, wherein the data comprises at least one of: a hybrid automatic repeat request indication for uplink communications; a transmit power control indication for the uplink communications; a timing advance command; a preemption indication; a wakeup signal; a paging indication; or a discontinuous reception indication.

Clause 38: One or more apparatuses, comprising: one or more memories comprising executable instructions; and one or more processors configured to execute the executable instructions and cause the one or more apparatuses to perform a method in accordance with any one of Clauses 1-37.

Clause 39: One or more apparatuses, comprising: one or more memories; and one or more processors, coupled to the one or more memories, configured to cause the one or more apparatuses to perform a method in accordance with any one of Clauses 1-37.

Clause 40: One or more apparatuses, comprising: one or more memories; and one or more processors, coupled to the one or more memories, configured to perform a method in accordance with any one of Clauses 1-37.

Clause 41: One or more apparatuses, comprising means for performing a method in accordance with any one of Clauses 1-37.

Clause 42: One or more non-transitory computer-readable media comprising executable instructions that, when executed by one or more processors of one or more apparatuses, cause the one or more apparatuses to perform a method in accordance with any one of Clauses 1-37.

Clause 43: One or more computer program products embodied on one or more computer-readable storage media comprising code for performing a method in accordance with any one of Clauses 1-37.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
receive a superimposed signal over a set of time frequency resources, the superimposed signal corresponding to a group common downlink control information (GC-DCI), the superimposed signal comprising a combination of a plurality of sequences;
detect, among the plurality of sequences, at least one sequence of a first set of sequences associated with the apparatus; and
decode the at least one sequence to obtain data for the apparatus.

2. The apparatus of claim 1, wherein each sequence of the plurality of sequences is based on a respective bit pattern corresponding to data carried in the GC-DCI.

3. The apparatus of claim 1, wherein:
the superimposed signal is a linear combination of the plurality of sequences; and
each sequence is weighted by a respective precoder coefficient corresponding to a user equipment (UE) group associated with the sequence.

4. The apparatus of claim 1, wherein:
the first set of sequences is common to a plurality of user equipment (UE) groups comprising a first UE group that includes the apparatus; and
the at least one sequence is scrambled by a scrambling code common to the first UE group.

5. The apparatus of claim 4, wherein the first UE group consists of the apparatus.

6. The apparatus of claim 4, wherein the first UE group comprises a plurality of UEs.

7. The apparatus of claim 6, wherein the at least one sequence comprises a first sequence based on the data for the apparatus and data for a second UE.

8. The apparatus of claim 4, wherein the one or more processors are configured to cause the apparatus to:
receive signaling indicating that the apparatus belongs to the first UE group; and
receive a configuration of the scrambling code.

9. The apparatus of claim 1, wherein:
the plurality of sequences are associated with a plurality of user equipment (UE) groups comprising a first UE group that includes the apparatus; and
the first set of sequences is uniquely associated with first UE group.

10. The apparatus of claim 9, wherein the one or more processors are configured to cause the apparatus to:
receive a configuration of the first set of sequences.

11. The apparatus of claim 10, wherein the configuration of the first set of sequences comprises a sequence hopping pattern.

12. The apparatus of claim 10, wherein the one or more processors are configured to cause the apparatus to:
receive an indication of other sets of sequences associated with other UE groups in the plurality of UE groups.

13. The apparatus of claim 9, wherein:
the apparatus is associated with the first UE group based on one or more characteristics of a channel between the apparatus and a network entity.

14. The apparatus of claim 9, wherein the one or more processors are configured to cause the apparatus to:
receive signaling indicating that the apparatus belongs to the first UE group.

15. The apparatus of claim 1, wherein a number of sequences included in the first set of sequences is based on a number of bits represented by one sequence of the first set of sequences.

16. The apparatus of claim 1, wherein to detect the at least one sequence, the one or more processors are configured to cause the apparatus to perform non-coherent detection to detect the at least one sequence.

17. The apparatus of claim 1, wherein the one or more processors are configured to cause the apparatus to receive an indication of the set of time frequency resources scheduled for the superimposed signal.

18. The apparatus of claim 1, wherein the data comprises at least one of:
a hybrid automatic repeat request indication for uplink communications;
a transmit power control indication for the uplink communications;
a timing advance command;
a preemption indication;
a wakeup signal;
a paging indication; or
a discontinuous reception indication.

19. An apparatus configured for wireless communications, comprising:
one or more memories; and
one or more processors coupled to the one or more memories, the one or more processors being configured to cause the apparatus to:
generate a superimposed signal comprising a combination of a plurality of sequences associated with a plurality of user equipment (UE) groups, wherein each sequence of the plurality of sequences is based on a respective bit pattern corresponding to data for a respective UE group associated with the sequence; and
send the superimposed signal over a set of time frequency resources, the superimposed signal corresponding to a group common downlink control information (GC-DCI).

20. A method for wireless communications by an apparatus comprising:
receiving a superimposed signal over a set of time frequency resources, the superimposed signal corresponding to a group common downlink control information (GC-DCI), the superimposed signal comprising a combination of a plurality of sequences;
detecting, among the plurality of sequences, at least one sequence of a first set of sequences associated with the apparatus; and
decoding the at least one sequence to obtain data for the apparatus.
